(19) United States
(12) Patent Application Publication
(10) Pub. No.: US 2015/0370043 A1
(43) Pub. Date: Dec. 24, 2015

(54) MINI WIDE-ANGLE LENS MODULE

(71) Applicant: AURAS Technology Co., Ltd., New Taipei City (TW)

(72) Inventor: SHI-HWA HUANG, New Taipei City (TW)

(21) Appl. No.: 14/742,879

(22) Filed: Jun. 18, 2015

(30) Foreign Application Priority Data
Jun. 20, 2014 (TW) 103121411

(51) Int. Cl. G02B 13/00; G02B 5/20; G02B 27/00; G02B 9/60

(52) U.S. Cl. CPC G02B 13/0045; G02B 9/60; G02B 5/208; G02B 27/0025

(57) ABSTRACT

A mini wide-angle lens module includes a first lens, a second lens, an aperture, a third lens, a fourth lens and a fifth lens. The first lens and the fifth lens have negative refractive power. The second lens, the third lens and the fourth lens have positive refractive power. The mini wide-angle lens module satisfies at least one of the following material relationships: (1) 0<V1−V2<20, (2) 1.78<I5<2.2, 16<V5<35, (3) 0.75<I3/I1<0.95, 1.05<I5/I1<1.25, 15<V3−V1<40 and 20<V1−V5<45, and (4) 1.65<I2<2.2, 35<V2<70, V4−V5>20 and I5−I4<0.4, wherein V1, V2, V3, V4 and V5 are ABBE numbers, and I1, I2, I3, I4 and I5 are refractive indices.

### FIELD OF THE INVENTION

The present invention relates to a wide-angle lens module, and more particularly to a mini wide-angle lens module.

### BACKGROUND OF THE INVENTION

Recently, the general trends in designing electronic devices are toward small size, light weightiness and easy portability in order to meet the users' requirements. For example, a lens module is developed toward miniaturization. As a consequence, the lens module can be applied to a mobile device, a vehicular device, an exercise device, a safety monitoring device, and so on. However, even if the lens module is developed toward miniaturization, the lens module with higher field of view (FOV) is well liked to the user because the lens module with higher FOV can capture the wider vision range.

However, if the FOV of the lens module is larger than 90 degrees, image aberration or distortion occurs easily. Conventionally, the lens module is equipped with plural lenses for correcting the image aberration or distortion. The arrangement of the plural lenses increases the overall thickness of the lens module and is detrimental to miniaturization of the lens module. Therefore, it is an important issue for those skilled in the art to provide a lens module with the benefits of small size and high FOV while achieving the high imaging quality. For example, an imaging lens assembly disclosed in Taiwanese Patent No. 1416197 is related to the relationships between plural focal lengths of plural lenses in the imaging lens assembly. However, the materials of the plural lenses and the material-related optical parameters (e.g., the ABBE number or the refractive index) are not described or studied in the above literature.

Moreover, the back focal length (i.e., the distance between the last lens of the lens module and the imaging plane) of the conventional mini lens module is very short. Consequently, the lens module is usually assembled by a COB (chip on board) packaging process. As known, the COB packaging process may increase the fabricating cost. Moreover, since most of the lenses within the mini lens module are made of plastic materials, the optical loss is very serious. Consequently, the image captured by the mini lens module is usually dark to a certain extent.

From the above discussions, the conventional mini lens module needs to be further improved.

### SUMMARY OF THE INVENTION

An object of the present invention provides a mini wide-angle lens module with specially-designed focal length relationships between lenses and specially-designed material relationships between lenses. Consequently, the mini wide-angle lens module has the benefits of small size, high FOV and excellent imaging quality.

In accordance with an aspect of the present invention, there is provided a mini wide-angle lens module. The mini wide-angle lens module includes a first lens with negative refractive power, a second lens with positive refractive power, a third lens with positive refractive power, a fourth lens with positive refractive power, and a fifth lens with negative refractive power. The first lens, the second lens, the third lens, the fourth lens and the fifth lens are sequentially arranged from an object side to an image side along an optical axis. The mini wide-angle lens module satisfies at least one of following four material relationships: (1) 0<V1−V2<20, (2) 1.78<I5<2.2, 16<V5<35, and the fifth lens has a concave object-side surface and a convex image-side surface, (3) 0.75<I3/I1<0.95, 1.05<I5/I1<1.25, 15<V3−V1<40 and 20<V1−V5<45, and (4) 1.65<I2<2.2, 35<V2<70, V4−V5>20 and I5−I4<0.4. In the above relationships, V1 is an ABBE number of the first lens, V2 is an ABBE number of the second lens, V3 is an ABBE number of the third lens, V4 is an ABBE number of the fourth lens, and V5 is an ABBE number of the fifth lens. Moreover, I1 is a refractive index of the first lens, I2 is a refractive index of the second lens, I3 is a refractive index of the third lens, I4 is a refractive index of the fourth lens, and I5 is a refractive index of the fifth lens.

In an embodiment, the mini wide-angle lens module further satisfies a following relationship: −3.2<f/f1<−0.78, wherein f is an overall focal length of the mini wide-angle lens module, and f1 is a focal length of the first lens.

In an embodiment, the mini wide-angle lens module further satisfies a following relationship: 1<f/f4<2, wherein f is an overall focal length of the mini wide-angle lens module, and f4 is a focal length of the fourth lens.

In an embodiment, the mini wide-angle lens module further satisfies a following relationship: f1/f2<0, wherein f1 is a focal length of the first lens, and f2 is a focal length of the second lens.

In an embodiment, the mini wide-angle lens module further includes an electronic photosensitive element. An object to be captured is imaged on the electronic photosensitive element. The mini wide-angle lens module further satisfies a following relationship: 1<ImgH/f<2, wherein ImgH is a half of a diagonal line of an effective pixel region of the electronic photosensitive element, and f is an overall focal length of the mini wide-angle lens module.

In an embodiment, the mini wide-angle lens module further includes an electronic photosensitive element. An object to be captured is imaged on the electronic photosensitive element. The mini wide-angle lens module further satisfies a following relationship: TTL/ImgH<3, wherein TTL is a distance between an object-side surface of the first lens and the electronic photosensitive element along the optical axis, and ImgH is a half of a diagonal line of an effective pixel region of the electronic photosensitive element.

In an embodiment, the mini wide-angle lens module further includes an aperture. The aperture is arranged between the second lens and the third lens.

In an embodiment, the mini wide-angle lens module further includes an infrared filter. The infrared filter is arranged between the fifth lens and an imaging surface, so that optical noise is filtered off by the infrared filter.

In an embodiment, the mini wide-angle lens module is assembled by a leadless chip carrier (LCC) packaging process.

In an embodiment, all of the first lens, the second lens, the third lens, the fourth lens and the fifth lens are made of glass materials.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the structure of a mini wide-angle lens module according to an embodiment of the present invention;

FIG. 2 illustrates an optical data table of the mini wide-angle lens module according to the embodiment of the present invention; and

FIG. 3 schematically illustrates modulation transfer function (MTF) curves obtained by the optical data table of FIG. 2.

### DETAILED DESCRIPTION OF THE PREFERRED EMBODIMENT

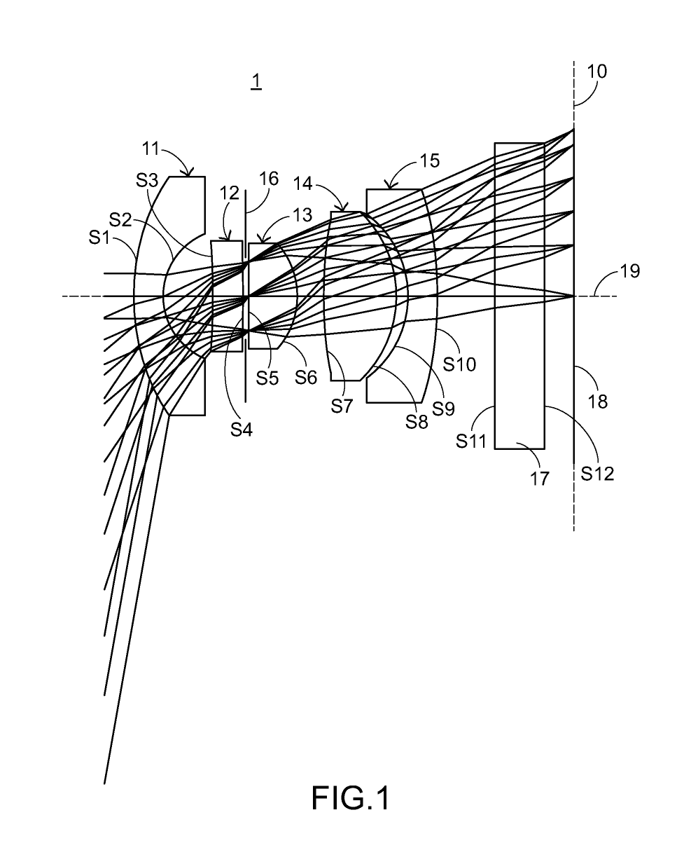

FIG. 1 is a schematic view illustrating the structure of a mini wide-angle lens module according to an embodiment of the present invention. From an object side (i.e., the side of the object to be captured) to an image side (i.e., the side of the image) along an optical axis 19, the mini wide-angle lens module 1 comprises a first lens 11, a second lens 12, an aperture 16, a third lens 13, a fourth lens 14 and a fifth lens 15 sequentially. When an object to be captured (not shown) is shot by the mini wide-angle lens module 1, a light beam is transmitted through the first lens 11, the second lens 12, the aperture 16, the third lens 13, the fourth lens 14 and the fifth lens 15 and projected on an imaging surface 10. In this embodiment, the mini wide-angle lens module 1 further comprises an electronic photosensitive element 18 and an infrared filter 17. The electronic photosensitive element 18 is located at the imaging surface 10 for imaging the object thereon. The infrared filter 17 is arranged between the fifth lens 15 and the imaging surface 10 for filtering off undesired optical noise and thus increasing the optical performance.

The first lens 11 has negative refractive power. The first lens 11 is a meniscus lens having a convex object-side surface S1 and a concave image-side surface S2. The first lens 11 is used for increasing the FOV of the mini wide-angle lens module 1. The second lens 12 has positive refractive power. The lens 12 has a concave object-side surface S3 and a convex image-side surface S4. After the image aberration of the light beam passing through the first lens 11 is corrected by the second lens 12, the corrected light beam is directed to the aperture 16. The symmetry and equilibrium of the image aberration of the received light beam are adjusted by the aperture 16. The third lens 13 has positive refractive power. The lens 13 has a planar object-side surface S5 and a convex image-side surface S6. After the light beam passing through the aperture 16 is converged by the third lens 13, the light beam is directed to the fourth lens 14. The fourth lens 14 has positive refractive power. The fourth lens 14 has a convex object-side surface S7 and a convex image-side surface S8. After the light beam passing through the third lens 13 is converged by the fourth lens 14, the light beam is directed to the fifth lens 15. The fifth lens 15 has negative refractive power. The fifth lens 15 is an inverse meniscus lens having a concave object-side surface S9 and a convex image-side surface S10. After the image aberration of the light beam passing through the fourth lens 14 is corrected by the fifth lens 15, the corrected light beam is directed to the electronic photosensitive element 18.

In an embodiment, the mini wide-angle lens module 1 satisfies the following focal length relationship: −3.2<f/f1<−0.78, wherein f is the overall focal length of the mini wide-angle lens module 1, and f1 is the focal length of the first lens 11. According to the evidence from experience, this design can increase the FOV of the mini wide-angle lens module 1, and the first lens 11 can be easily fabricated. Moreover, the mini wide-angle lens module 1 further satisfies the following focal length relationship: 1<f/f4<2, wherein f4 is the focal length of the fourth lens 14. According to the evidence from experience, this design can balance the total aberration of the mini wide-angle lens module 1, and the fourth lens 14 can be easily fabricated. Moreover, the mini wide-angle lens module 1 further satisfies the following focal length relationship: 1<ImgH/f<2, wherein ImgH is a half of a diagonal line of an effective pixel region of the electronic photosensitive element 18. According to the software simulation result, this design can increase the FOV of the mini wide-angle lens module 1. Moreover, the mini wide-angle lens module 1 further satisfies the following focal length relationship: TTL/ImgH<3, wherein TTL is the distance between the object-side surface S1 of the first lens 11 and the electronic photosensitive element 18 along the optical axis 19. According to the software simulation result, this design can reduce the volume of the mini wide-angle lens module 1. Moreover, the mini wide-angle lens module 1 further satisfies the following focal length relationship: f1/f2<0, wherein f2 is the focal length of the second lens 12. By this design, one of the first lens 11 and the second lens 12 has the positive focal length, and the other of first lens 11 and the second lens 12 has the negative focal length. According to the software simulation result, this design can reduce the total aberration of the mini wide-angle lens module 1.

Moreover, the mini wide-angle lens module 1 satisfies the following material relationship: 0<V1−V2<20, wherein V1 is an ABBE number of the first lens 11, and V2 is an ABBE number of the second lens 12. According to the software simulation result, this design can reduce the total color aberration of the mini wide-angle lens module 1. Moreover, the mini wide-angle lens module 1 further satisfies the following material relationship: 1.78<I5<2.2, wherein I5 is a refractive index of the fifth lens 15. According to the software simulation result, this design can reduce the total aberration of the mini wide-angle lens module 1 while reducing the volume of the mini wide-angle lens module 1 and maintaining good focusing capability of the mini wide-angle lens module 1. Moreover, the mini wide-angle lens module 1 further satisfies the following material relationship: 16<V5<35, wherein V5 is an ABBE number of the fifth lens 15. According to the software simulation result, this design can reduce the total color aberration of the mini wide-angle lens module 1 while reducing the volume of the mini wide-angle lens module 1.

Moreover, the mini wide-angle lens module 1 satisfies the following material relationship: 0.75<I3/I1<0.95, wherein I1 is a refractive index of the first lens 11, and 13 is a refractive index of the third lens 13. According to the software simulation result, this design can reduce the total aberration of the mini wide-angle lens module 1 and cause aberration complementation of all lenses of the mini wide-angle lens module 1. Moreover, the mini wide-angle lens module 1 satisfies the following material relationship: 1.05<I5/I1<1.25. According to the software simulation result, this design can reduce the total aberration of the mini wide-angle lens module 1 and cause aberration complementation of all lenses of the mini wide-angle lens module 1. Moreover, the mini wide-angle lens module 1 satisfies the following material relationship: 15<V3−V1<40, wherein V1 is an ABBE number of the first lens 11, and V3 is an ABBE number of the third lens 13. According to the software simulation result, this design can reduce the total color aberration of the mini wide-angle lens module 1 and cause color aberration complementation of all lenses of the mini wide-angle lens module 1. Moreover, the mini wide-angle lens module 1 satisfies the following material relationship: 20<V1−V5<45.

Moreover, the mini wide-angle lens module 1 satisfies the following material relationship: 1.65<I2<2.2, wherein I2 is a refractive index of the second lens 12. According to the software simulation result, this design can reduce the total aberration of the mini wide-angle lens module 1 while reducing the volume of the mini wide-angle lens module 1 and maintaining good focusing capability of the mini wide-angle lens module 1. Moreover, the mini wide-angle lens module 1 satisfies the following material relationship: 35<V2<70, wherein V2 is an ABBE number of the second lens 12. According to the software simulation result, this design can reduce the total color aberration of the mini wide-angle lens module 1 while reducing the volume of the mini wide-angle lens module 1. Moreover, the mini wide-angle lens module 1 satisfies the following material relationship: V4−V5>20, wherein V4 is an ABBE number of the fourth lens 14, and V5 is an ABBE number of the fifth lens 15. According to the software simulation result, this design can reduce the total color aberration of the mini wide-angle lens module 1 and cause color aberration complementation of all lenses of the mini wide-angle lens module 1. Moreover, the mini wide-angle lens module 1 satisfies the following material relationship: I5−I4<0.4, wherein I4 is a refractive index of the fourth lens 14, and I5 is a refractive index of the fifth lens 15. According to the software simulation result, this design can reduce the total aberration of the mini wide-angle lens module 1 and cause aberration complementation of all lenses of the mini wide-angle lens module 1.

It is noted that the above software simulation method is well known to those skilled in the art. For example, the total aberration of the mini wide-angle lens module can be obtained according to the simulation result generated from the integrated calculation of the main light beam and the edge light beam at various specified parameters (e.g., positions, angles, or refractive indices). Consequently, the detailed descriptions thereof are omitted.

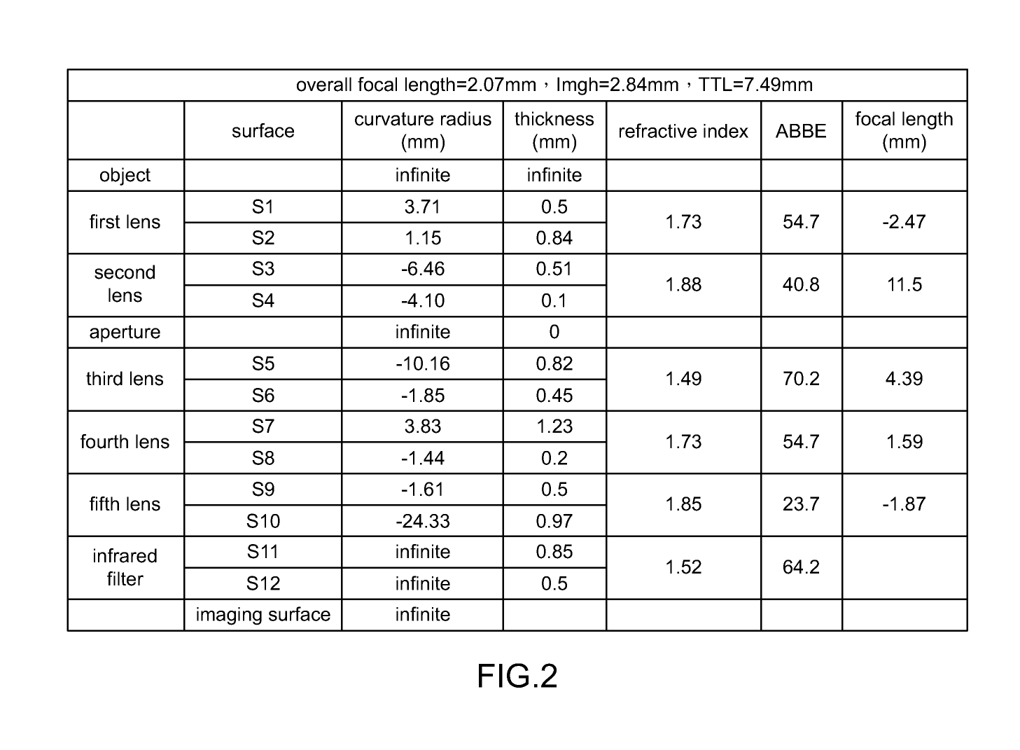

FIG. 2 illustrates an optical data table of the mini wide-angle lens module according to the embodiment of the present invention. In this embodiment, the mini wide-angle lens module 1 has an overall focal length f=2.07 mm, and the first length 11 has a focal length f1=−2.47. The relationship between f and f1 is expressed as: f/f1=−0.84. Moreover, the fourth lens 14 has a focal length f4=1.59 mm. Consequently, the relationship between the overall focal length f of the mini wide-angle lens module 1 and the focal length f4 of the fourth lens 14 is expressed as: f/f4=1.3.

Moreover, in this embodiment, the half of the diagonal line of the effective pixel region of the electronic photosensitive element 18 (i.e., ImgH) is equal to 2.84 mm. Consequently, the relationship between the overall focal length f of the mini wide-angle lens module 1 and ImgH is expressed as: ImgH/f=1.37. Moreover, the distance between the object-side surface S1 of the first lens 11 and the electronic photosensitive element 18 along the optical axis 19 (i.e., TTL) is equal to 7.49 mm. Consequently, the relationship between TTL and ImgH is expressed as: TTL/ImgH=2.64. Moreover, the second lens 12 has a focal length f2=11.5 mm. Consequently, the relationship between the focal length f1 of the first lens 11 and the focal length f2 of the second lens 12 is expressed as: f1/f2=−0.21.

Moreover, in this embodiment, the ABBE number V1 of the first lens 11 is 54.7, and the ABBE number V2 of the second lens 12 is 40.8. Consequently, the relationship between the ABBE number V1 of the first lens 11 and the ABBE number V2 of the second lens 12 is expressed as: V1−V2=13.9.

Moreover, in this embodiment, the refractive index I1 of the first lens 11 is 1.73, and the refractive index I3 of the third lens 13 is 1.49. Consequently, the relationship between the refractive index I1 of the first lens 11 and the refractive index I3 of the third lens 13 is expressed as: I3/I1=0.86. Moreover, the refractive index I5 of the fifth lens 15 is 1.85. Consequently, the relationship between the refractive index I5 of the fifth lens 15 and the refractive index I1 of the first lens 11 is expressed as: I5/I1=1.07. Moreover, the ABBE number V3 of the third lens 13 is 70.2. Consequently, the relationship between the ABBE number V3 of the third lens 13 and the ABBE number V1 of the first lens 11 is expressed as: V3−V1=15.5. Moreover, the ABBE number V5 of the fifth lens 15 is 23.7. Consequently, the relationship between the ABBE number V1 of the first lens 11 and the ABBE number V5 of the fifth lens 15 is expressed as: V1−V5=31.

Moreover, in this embodiment, the refractive index I2 of the second lens 12 is 1.88, and the ABBE number V2 of the second lens 12 is 40.8. Moreover, the ABBE number V4 of the fourth lens 14 is 54.7, and the ABBE number V5 of the fifth lens 15 is 23.7. Consequently, the relationship between the ABBE number V4 of the fourth lens 14 is 54.7 and the ABBE number V5 of the fifth lens 15 is expressed as: V4−V5=31. Moreover, the refractive index I4 of the fourth lens 14 is 1.73. Consequently, the relationship between the refractive index I5 of the fifth lens 15 and the refractive index I4 of the fourth lens 14 is expressed as: I5−I4=0.12.

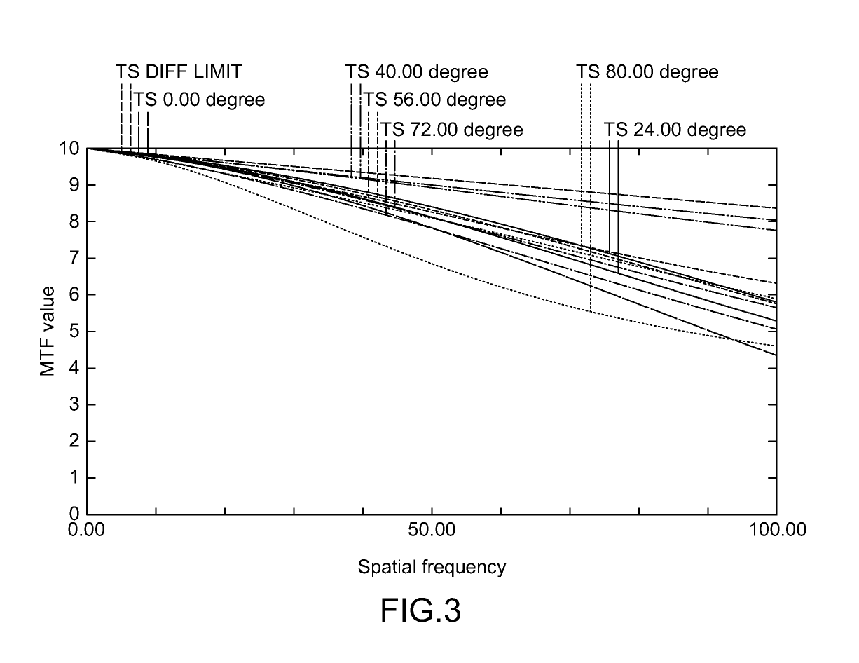

FIG. 3 schematically illustrates modulation transfer function (MTF) curves obtained by the optical data table of FIG. 2. In FIG. 3, the y-axis coordinate indicates the modulation transfer function value. The modulation transfer function value is related to the resolving power of the mini wide-angle lens module. That is, the modulation transfer function value is the ability of the mini wide-angle lens module to faithfully reproduce the texture of the captured object. In industries, the modulation transfer function value is an important index of the imaging quality. In FIG. 3, the x-axis coordinate indicates the spatial frequency. The tangential component T indicates the resolving power of the mini wide-angle lens module with respect to the tangential lines (i.e., the lines tangential to the center concentric circle of the electronic photosensitive element). The sagittal component S indicates the resolving power of the mini wide-angle lens module with respect to the radial lines (i.e., the lines passing through the center of the electronic photosensitive element). FIG. 3 shows the relationships between the modulation transfer function values and the spatial frequencies for the tangential components T and the sagittal components S at 0 degree, 24 degree, 40 degree, 56 degree, 72 degree and 80 degree.

According to the drawing, it is found that the mini wide-angle lens module of the present invention has the benefits of small size, high FOV and excellent imaging quality. The way of reading the MTF curves is well known to those skilled in the art, and is not redundantly described herein.

In an embodiment, one of the first lens 11, the second lens 12, the aperture 16, the third lens 13, the fourth lens 14 and the fifth lens 15 is made of a glass material or a plastic material. Preferably but not exclusively, all of the first lens 11, the second lens 12, the aperture 16, the third lens 13, the fourth lens 14 and the fifth lens 15 are made of glass materials. Consequently, the optical loss of the mini wide-angle lens module 1 is reduced. In other words, the image obtained by the mini wide-angle lens module 1 is bright. Moreover, the resolution of the image can be increased to 13M˜18M.

It is noted that the back focal length of the mini wide-angle lens module 1 (i.e., the distance between the fifth lens 15 and the imaging surface 10) is long enough. The mini wide-angle lens module 1 is assembled by a leadless chip carrier (LCC) packaging process such as a ceramic leadless chip carrier (CLCC) packaging process or a plastic leadless chip carrier (PLCC) packaging process. Consequently, the fabricating cost of the mini wide-angle lens module is reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A mini wide-angle lens module, comprising:
a first lens with negative refractive power;
a second lens with positive refractive power;
a third lens with positive refractive power;
a fourth lens with positive refractive power; and
a fifth lens with negative refractive power,
wherein the first lens, the second lens, the third lens, the fourth lens and the fifth lens are sequentially arranged from an object side to an image side along an optical axis,
wherein the mini wide-angle lens module satisfies at least one of following four material relationships: (1) 0<V1−V2<20, (2) 1.78<I5<2.2, 16<V5<35, and the fifth lens has a concave object-side surface and a convex image-side surface, (3) 0.75<I3/I1<0.95, 1.05<I5/I1<1.25, 15<V3−V1<40 and 20<V1−V5<45, and (4) 1.65<I2<2.2, 35<V2<70, V4−V5>20 and I5−I4<0.4, wherein V1 is an ABBE number of the first lens, V2 is an ABBE number of the second lens, V3 is an ABBE number of the third lens, V4 is an ABBE number of the fourth lens, V5 is an ABBE number of the fifth lens, I1 is a refractive index of the first lens, I2 is a refractive index of the second lens, I3 is a refractive index of the third lens, I4 is a refractive index of the fourth lens, and I5 is a refractive index of the fifth lens.

2. The mini wide-angle lens module according to claim 1, wherein the mini wide-angle lens module further satisfies a following relationship: −3.2<f/f1<−0.78, wherein f is an overall focal length of the mini wide-angle lens module, and f1 is a focal length of the first lens.

3. The mini wide-angle lens module according to claim 1, wherein the mini wide-angle lens module further satisfies a following relationship: 1<f/f4<2, wherein f is an overall focal length of the mini wide-angle lens module, and f4 is a focal length of the fourth lens.

4. The mini wide-angle lens module according to claim 1, wherein the mini wide-angle lens module further satisfies a following relationship: f1/f2<0, wherein f1 is a focal length of the first lens, and f2 is a focal length of the second lens.

5. The mini wide-angle lens module according to claim 1, further comprising an electronic photosensitive element, wherein an object to be captured is imaged on the electronic photosensitive element, wherein the mini wide-angle lens module further satisfies a following relationship: 1<ImgH/f<2, wherein ImgH is a half of a diagonal line of an effective pixel region of the electronic photosensitive element, and f is an overall focal length of the mini wide-angle lens module.

6. The mini wide-angle lens module according to claim 1, wherein further comprising an electronic photosensitive element, wherein an object to be captured is imaged on the electronic photosensitive element, wherein the mini wide-angle lens module further satisfies a following relationship: TTL/ImgH<3, wherein TTL is a distance between an object-side surface of the first lens and the electronic photosensitive element along the optical axis, and ImgH is a half of a diagonal line of an effective pixel region of the electronic photosensitive element.

7. The mini wide-angle lens module according to claim 1, further comprising an aperture, wherein the aperture is arranged between the second lens and the third lens.

8. The mini wide-angle lens module according to claim 1, further comprising an infrared filter, wherein the infrared filter is arranged between the fifth lens and an imaging surface, so that optical noise is filtered off by the infrared filter.

9. The mini wide-angle lens module according to claim 1, wherein the mini wide-angle lens module is assembled by a leadless chip carrier (LCC) packaging process.

10. The mini wide-angle lens module according to claim 1, wherein all of the first lens, the second lens, the third lens, the fourth lens and the fifth lens are made of glass materials.
